(19) United States
(12) Patent Application Publication
(10) Pub. No.: US 2013/0138019 A1
(43) Pub. Date: May 30, 2013

(54) METHOD OF TREATING WOUND IN SAC-LIKE CAVITY PRESENT INSIDE OF SUBJECT

(71) Applicants: Takayasu MIKKAICHI, Tokyo (JP); Takayuki SUZUKI, Yokohama (JP)

(72) Inventors: Takayasu MIKKAICHI, Tokyo (JP); Takayuki SUZUKI, Yokohama (JP)

(73) Assignee: OLYMPUS MEDICAL SYSTEMS CORPORATION, Tokyo (JP)

(21) Appl. No.: 13/307,403

(22) Filed: Nov. 30, 2011

(51) Int. Cl. A61H 7/00

(52) U.S. Cl. 601/6

(57) ABSTRACT

The present invention is a method of treating a wound in a sac-like cavity inside of a subject using negative pressure therapy. In the treatment method, an applicator connected to a negative pressure source and a closing member that closes an opening of the sac-like cavity are inserted to the sac-like cavity. The applicator is placed in the sac-like cavity and the closing member is placed in contact with the edge of an opening section of the sac-like cavity. The negative power source is driven, and a negative pressure of a desired value is applied to the sac-like cavity from the negative pressure source. The negative pressure of the desired value in the sac-like cavity is maintained, and negative pressure therapy is performed.

### BACKGROUND OF THE INVENTION

1. Field of the Invention

The present invention relates to a method of treating a wound in a sac-like lumen formed inside of a subject or a sac-like lumen present inside of a subject. In particular, the present invention relates to a method of treating a wound through application of negative pressure on the sac-like lumen.

2. Description of the Related Art

Various types of wounds occur in sac-like cavities inside of a subject. For example, when complications occur from an anterior resection of the rectum, an anastomotic leakage may occur and an abscess may be formed. The abscess is currently treated by a number of methods. In one method, the abscess is surgically drained and washed, and a drain is indwelled there. In another method, broad-spectrum antibiotics are conservatively administered. Furthermore, the abscess may be treated by restriction of food intake using intravenous nutrition. However, none of these treatments are definitive. The best method for treating abscesses is still unknown.

Appendicitis is known as an example of a wound in a lumen present within the body. Appendicitis is frequently treated by resection of the appendix itself. On the other hand, even when appendicitis is suspected, treatment may be possible in some instances without resection of the appendix. Moreover, the problem may not actually be appendicitis.

As a method of treating a patient with an abscess, a wound care treatment using negative pressure is known, for example, as “negative pressure therapy” described in JP-A-2006-505316. According to a specific example of this treatment, a foam serving as a collecting means is positioned and disposed in a sac-like cavity (including abscesses and the like) within a patient's body using an introducer. The foam is, for example, an open-cell polyurethane ether foam. The foam is connected to a vacuum device by a thin, flexible tube. The vacuum container includes a collecting device that collects effluents, such as fluid, forcibly drawn from the sac-like cavity, and a negative pressure source that applies negative pressure on the cavity.

When placement of the foam is completed, the introducer is removed. Next, negative pressure is applied to the foam. The negative pressure is evenly applied to the inner walls of the cavity by the foam. Therefore, the sac-like cavity shrinks in size. As a result, effluents, such as fluid and necrotic tissue, present within the cavity are forcibly discharged from the cavity. The discharge is collected through the tube by the fluid collecting device. As a result, the wound within the cavity is treated. After the treatment is completed, the foam is removed.

The negative pressure therapy requires the sac-like cavity to be sealed. In the procedure described in JP-A-2006-505316, sealing of the sac-like cavity is achieved by the shape of the cavity that is being treated using the foam serving as a pressure distributor, the structure of the pathway of the body (such as the patient's anus) into which the introducer is inserted, an adhesive drape used in vacuum adjunctive treatment of the body surface, or the like.

However, in the above-described negative pressure therapy, matching the shape and size of the foam to the shape and size of the interior of the cavity is difficult. Therefore, matching the foam and the cavity requires labor, such as preparing a plurality of foams of different sizes or cutting the foam to match the size and shape of the cavity. In addition, the affected area is sealed by the shape of the foam and the shape of the cavity, by a natural orifice (such as the anus), and/or by a drape in the outlet section leading outside of the body. Therefore, sealing may be incomplete, or negative pressure may be unnecessarily applied to an area other than the affected area. As a result, effective sealing of only the affected area cannot be performed, and complications may occur.

### SUMMARY OF THE INVENTION

Negative pressure is required to be applied with certainty to a sac-like cavity, such as the appendix or an abscess, within a subject's body, thereby creating a state allowing the wound to heal.

According to a typical embodiment, a method of treating a wound in a sac-like cavity inside of a subject using negative pressure therapy is provided. The method includes: a first step of introducing, to the sac-like cavity, an applicator connected to a negative pressure source and a closing member that closes an opening of the cavity; a second step of placing the applicator in the sac-like cavity and placing the closing member in contact with the edge of an opening section of the sac-like cavity; a third step of driving the negative pressure source and applying negative pressure of a desired value to the sac-like cavity from the negative pressure source; and a fourth step of performing the treatment by maintaining the negative pressure of the desired value in the sac-like cavity. A step of inserting the applicator into the sac-like cavity, dilating the diameter of the applicator, and placing the applicator in contact with the inner wall of the cavity may be provided between the second step and the third step.

As a result, the sac-like cavity can be sealed with certainty. Negative pressure can be efficiently applied to only the interior of the cavity, and the negative pressure state can be maintained.

### BRIEF DESCRIPTION OF THE DRAWINGS

In the accompanying drawings:

FIG. 1 is a configuration diagram for explaining various embodiments of a treatment system for performing a negative pressure therapy method of the present invention;

FIG. 2A and FIG. 2B are diagrams for explaining a treatment device used in a first embodiment;

FIG. 3 is a flowchart for explaining the procedures in negative pressure therapy performed according to the first embodiment:

FIG. 4 shows explanatory diagrams for explaining the negative pressure therapy performed according to the first embodiment;

FIG. 5 shows diagrams for explaining treatment devices in variation examples;

FIG. 6 shows diagrams for explaining a treatment device used in a second embodiment and a method of use of the treatment device; and

FIG. 7 shows diagrams for explaining a treatment device used in a third embodiment and a method of use of the treatment device.

### DETAILED DESCRIPTION OF THE PREFERRED EMBODIMENTS

Preferred embodiments of a method of treating a wound in a sac-like cavity present inside of a subject of the present invention will hereinafter be described with reference to the drawings.

The sites on which the treatment of the present invention is performed include, in addition to sac-like cavities such as the subject's appendix, cavities that have a sac-like shape or are curved into a similar shape, such as a pustule or a diverticulum. The sites are collectively referred to, hereinafter, as a “sac-like cavity”. In the present invention, “treating a wound” refers to performing “negative pressure therapy” itself, in which negative pressure is applied to the sac-like cavity.

In addition, according to the embodiments described hereafter, an example is described in which a wound of the appendix as the sac-like cavity, or in other words, appendicitis is treated by the negative pressure therapy.

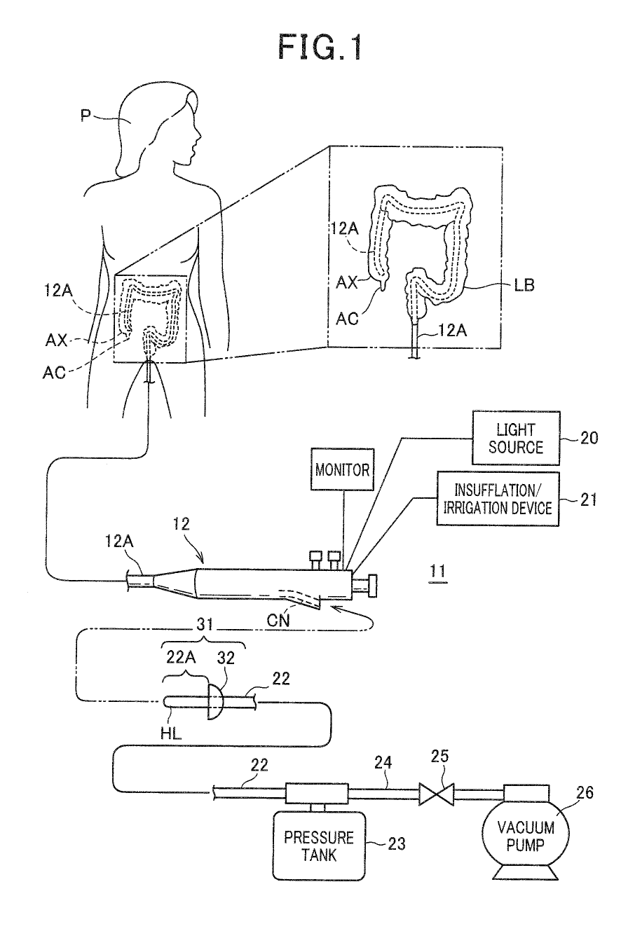

FIG. 1 shows a treatment system for performing the treatment. The treatment system is a system for performing the method of treating a wound in a sac-like cavity present inside of a subject of the present invention.

As shown in FIG. 1, a treatment system 1 includes an endoscopic device 11. The endoscopic device 11 includes a flexible endoscope 12 and a monitor 13. The endoscope 12 has a flexible inserting section 12A that can be inserted into a body cavity LB inside of a subject P. The endoscope 12 can display, on the monitor 13, an image captured by an image sensor element provided at the tip end of the inserting section 12A. Various channels CN (collectively referred to, hereafter, as simply a “channel”) for providing various functions required for endoscopic examination and treatment, such as air insufflation, irrigation, and treatment tool insertion, are formed in the inserting section 12A along the axial direction thereof.

The treatment system 1 includes, in addition to the endoscopic device 11, a light source 20, an insufflation/irrigation device 21, a suction catheter 22, a pressure tank 23, a tube 24, a valve (or a connector) 25, and a vacuum pump 26. The treatment system 1 further includes a treatment device 31.

The suction catheter 22 is guided through the channel in the inserting section 12a of the endoscope 12 to a sac-like cavity (appendix) AC inside of the subject P. The treatment device 31 is disposed at the tip end of the suction catheter 22. The pressure tank 23 is connected to the base of the suction catheter 22. The pressure tank 23 is connected to the vacuum pump 26 by the tube 24. The valve 25 that connects and disconnects the path is interposed midway of the tube 24. Therefore, when the valve 25 is open and the vacuum pump 26 is driven to exhaust air, the interior of the pressure tank 23, or in other words, the interior of the suction catheter 22 can be set to negative pressure of a desired value, and the negative pressure can be maintained.

The treatment device 31 includes an applicator 22A and a substantially circular closing member 32. The closing member 32 is disposed on the base side of the applicator 22A such as to be penetrated by the applicator 22.

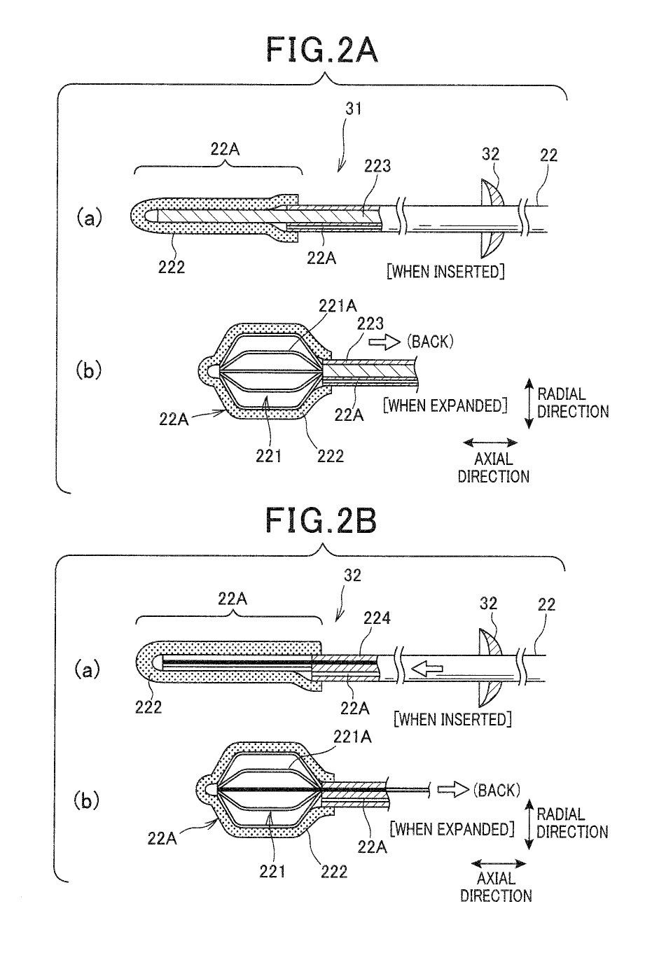

FIG. 2A and FIG. 2B each show an example of the applicator 22A. The applicator 22A includes a wire frame 221 and a covering material 222. The wire frame 221 forms a basket shape when expanded (dilated). The covering material 222 covers the outer side of the wire frame 221. The applicator 22A is integrally connected to the suction catheter 22. The covering material 222 is formed using polyurethane foam or a stretchable nylon mesh. The covering material 222 has numerous fine holes or is meshed.

The wire frame 221 is formed using a plurality of wires 221A composed of superelastic alloy wires or piano wires. The wire frame 221 is capable of adjusting the outward expansion of the plurality of wires 221A, or in other words, the shape of the basket of the applicator 22A depending on whether or not coercive force is applied by a sheath or wire, described hereafter. In a natural state in which outer force is not applied, the wires 221A of the applicator 22A shown in FIG. 2A expand outward by the elasticity of the plurality of wires 221A. On the other hand, in a natural state in which outer force is not applied, the wires 221A of the applicator 22A shown in FIG. 2B form a linear shape.

In the configuration shown in FIG. 2A, when the applicator 22A is inserted into the appendix AC, the wire frame 221 is housed within a sheath 223 in a non-dilated, rod-shaped state (see (a) “WHEN INSERTED” in FIG. 2A). After the applicator 22A is inserted into the appendix AC, the sheath 223 is pulled back, thereby exposing the wire frame 221. As a result, the wire frame 221 expands outward in the radial direction by the elasticity of the wire frame 221. Therefore, the overall applicator 22A expands into the basket shape (see (b) “WHEN EXPANDED” in FIG. 2A). At this time, the interior of the expanded wire frame 221 is hollow.

On the other hand, in the configuration shown in FIG. 2B, an operating wire 224 is threaded in the axial direction in a position on the inner diameter side, the inner diameter being formed by the plurality of wires 221A of the wire frame 221. The tip end section of the operating wire 224 is connected to the tip end of the plurality of wires 221A. Therefore, when the operating wire 224 is pushed towards the tip end side, the linear state of the plurality of wires 221A is maintained, and the overall wire frame 221 is rod-shaped. Conversely, when the operating wire 224 is pulled back, the plurality of wires 221A expand outward in the radial direction against the elasticity of the wires 221A. Therefore, the overall applicator 22A expands into the basket shape (see (b) “WHEN EXPANDED” in FIG. 2B). At this time, although a portion of the operating wire 224 is present, the interior of the expanded wire frame 221 is hollow.

In both applicators 22A shown in FIG. 2A and FIG. 2B, the amount by which the sheath 223 or the operating wire 224 is pulled back (towards the operator) can be adjusted. Depending on the degree of adjustment, the degree of outward expansion of the plurality of wires 221A, or in other words, the size of the applicator 22A in the axial direction and the radial direction can be adjusted.

The interior of the basket when expanded is hollow. Therefore, when negative pressure is applied to the suction catheter 22 from the pressure tank 23 (in other words, when suction is performed), the air within the appendix AC flows from outside of the applicator 22A, through the holes or the mesh of the covering material 222, into the applicator 22A. The air further passes from the applicator 22A, through an inner lumen 22A of the suction catheter 22, and reaches the pressure tank 23. As a result, the air is suctioned.

The closing member 32 is a flexible, non-porous silicon member. The shape of the closing member 32 is preferably curved towards the tip end of the applicator 22A. A reason for this is that the closing member 32 is placed in close contact with the edge of the opening of the appendix AC. Therefore, the diameter of the closing member 32 is of a size that covers the opening, and is preferably able to be selected depending on the patient. Here, an example of the size of the appendix AC and the size of the closing member 32 is as follows:

appendix: a length of about 50 mm to 100 mm, and an inner diameter of about 5 mm to 10 mm

closing member: composed of silicon, a diameter of about 20 mm to 30 mm, and a thickness of about 1 mm to 3 mm.

Here, the body cavity LB refers to an overall region from the anus to the cecum in the large intestine. The large intestine is from the rectum, the sigmoid colon, the descending colon, the transverse colon, the ascending colon, to the cecum. The sac-like cavity is a thin, finger-shaped cul-de-sac projecting from the posterior inner wall in the lower end of the cecum.

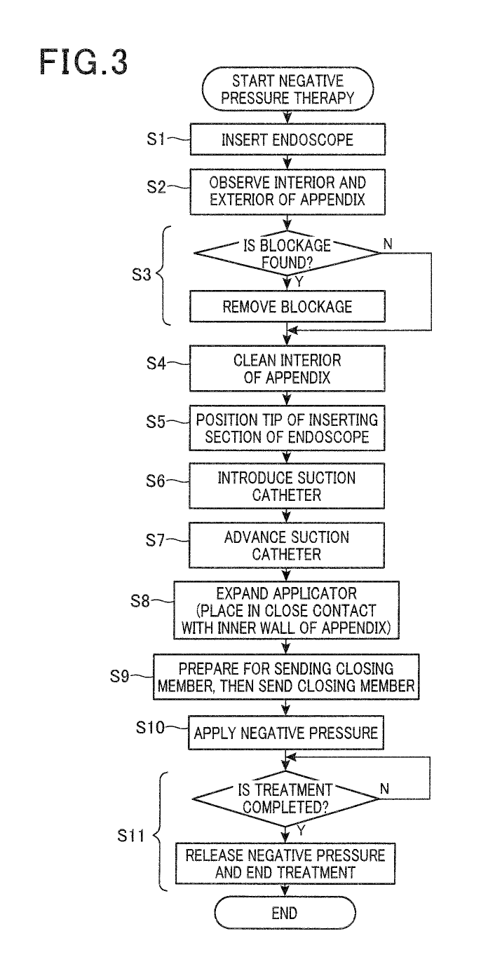

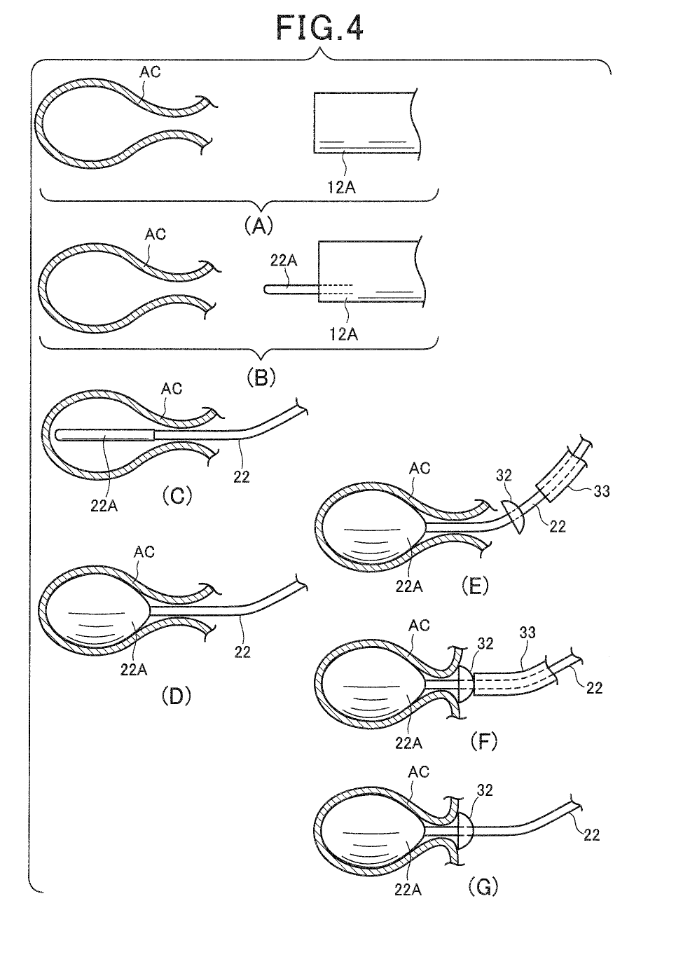

Next, procedures of negative pressure therapy using the treatment system 1 according to the present embodiment will be described with reference to FIG. 3 and FIG. 4.

The operator inserts the inserting section 12A of the endoscope 12 from the anus of the subject P, through the large intestine LB, into the appendix AC of the cecum AX (Step Si in FIG. 3).

Next, the operator observes the root portion and interior of the appendix AX with the endoscopic device 11 (Step S2). When, as a result of the observation, a cause for blockage of the appendix AC, such as a fecalith, is found, the blockage is removed using the treatment tool (Step S3). Furthermore, the insufflation/irrigation device 21 is driven and the interior of the appendix AC is cleaned (Step S4).

When this preparation is completed, the operator positions the inserting section 12A of the endoscope 12 such that the opening of the appendix AC is visible in front (Step S5; see (A) of FIG. 4). Then, the operator inserts the suction catheter 22 inside the subject P via the channel of the inserting section 12A and guides the tip end of the suction catheter 22, or in other words, the applicator 22A to the tip end of the inserting section 12A of the endoscope 22 (Step S6; see (B) of FIG. 4). As a result, the treatment device 31 is positioned such as to face the opening of the appendix AC.

When this positioning is completed, the suction catheter 22 is slowly advanced straight towards the opening of the appendix AC until the tip end of the suction catheter 22 comes into contact with the bottom section (the wall in the depth direction) of the appendix AC (Step S7). As a result, the applicator 22A in the tip end section of the suction catheter 22 is also slowly advanced. In accompaniment with this advancing movement, the tip end section of the suction catheter 22, or in other words, the applicator 22A enters the interior of the appendix AC. The applicator 22A in the tip end section of the suction catheter 22 comes into contact with the bottom section of the appendix AC (see (C) of FIG. 4).

When the applicator 22A is inserted into the cavity, the wire frame (221 is closed as described above, and the diameter of the wire frame 221 is small (see “WHEN INSERTED” in FIG. 2A and FIG. 2B). Therefore, the applicator 22A can be easily inserted into the cavity.

Next, as described above, the wire frame 221 is dilated, and the applicator 22A is expanded (see “WHEN EXPANDED” in FIG. 2A and FIG. 2B). As a result, the applicator 22A is placed in close contact with the inner wall of the appendix AC (Step S8; see (D) of FIG. 4). At this time, the applicator 22A expands to fit the size of the cavity due to the elasticity of the wire frame 221.

However, Step 58 at which the applicator 22A is placed in close contact with the inner wall of the appendix AC may not be required depending on the size of the cavity and the type of applicator 22A. In this instance, Step S8 is skipped and the procedure proceeds to the subsequent step.

Then the operator prepares for sending the closing member 32, and actually sends the closing member 32 toward the appendix AC (Step S9). Practically, with the applicator 22A and the suction catheter 22 made to remain in the appendix AC, the operator pulls the endoscope 12 from the patient's body, and inserts again the inserting section 12A of the endoscope 12 into the patient's body along the suction catheter 22 to a position which allows the endoscope 12 to observe the appendix AC. Then the operator applies the closing member 32 to the suction catheter 22 such that the proximal end part of the suction catheter 22 passes through the closing member 32. The closing member 32 is then sent along the suction catheter 22. To send the closing member 32, a pusher tube 33 is used to place the closing member 32 in contact with the peripheral section of the opening of the appendix AC (see (E) and (F) of FIG. 4). In this way, the suction catheter 22 and the closing member 32 can be set in the appendix AC. At this time, the section on the base end side of the suction catheter 22 from the anus of the patient P is outside of the body, and the suction catheter 22 is connected to the pressure tank 23.

In this state, the operator drives the vacuum pump 26 and holds the pressure tank 23 at a negative pressure of a desired value (Step S10). As a result, the negative pressure is also applied to the appendix AC via the suction catheter 22. After confirming the application of the negative pressure, the endoscope 12 is pulled from the patient's body. As a result of the application of negative pressure, as shown in (G) of FIG. 4, the closing member 32 comes into close contact with the peripheral section of the opening of the appendix AC, and pressure difference between the interior of the appendix AC and the outer side of the appendix AC is maintained with certainty. In other words, the pressure within the appendix AC is held at a negative pressure of a desired value. The negative pressure therapy is continuously performed on the patient by maintaining the above-described negative pressure state in which the suction catheter 22 is led outside of the body, for several hours or several days.

When the negative pressure therapy is completed, operation of the vacuum pump 26 is stopped, and the pressure of the pressure tank 23 is returned to atmospheric pressure (Step S11). The treatment is completed.

As described above, in the negative pressure therapy according to the present embodiment, the treatment device 31, or in other words, the applicator 22A formed integrally with the tip end section of the suction catheter 22 and the closing member 32 can be easily sent to the appendix AC. As a result of the advancing movement of the suction catheter 22 that is sent first, the applicator 22A at the tip end can be inserted into and held within the appendix AC. After the closing member 32 that is sent thereafter comes into contact with the edge of the opening section of the appendix AC, negative pressure is applied via the suction catheter 22. As a result, the closing member 32 comes into close contact with the opening of the appendix AC. Therefore, it is possible to place only the interior space of the appendix AC in the negative pressure state in a localized manner. In addition, the negative pressure state can be maintained. As a result, the negative pressure therapy can be easily performed on the appendix AC with certainty. In addition, because negative pressure is applied only in the area requiring negative pressure, unnecessary harm caused by negative pressure being applied to other areas does not occur.

Furthermore, in accompaniment with the wound being treated, the size of the cavity, such as the appendix AC, ordinarily decreases. In this instance, because of the elasticity of the wire frame 221, the diameter of the applicator 22A, or in other words, the overall size of the applicator 22A also decreases. Therefore, the applicator 22A can be placed in close contact with the inner wall of the cavity at all times. A more effective negative pressure therapy can be performed.

In addition, according to the present embodiment, the size of the applicator 22A can be adjusted through adjustment of the amount by which the sheath 223 or the operating wire 224 is pulled back (towards the operator). Therefore, the overall size of the applicator 22A can be adjusted depending on the size of the appendix AC that differs between individuals and on the state of treatment. As a result, an appropriate negative pressure therapy can be performed.

The foregoing embodiment has been exemplified about the treatment with which the applicator 22A and the suction catheter 22 are administered through a channel of the endoscope 12. However, this is not only the example, and the applicator and the suction catheter can be administered through an external channel attached to the outside of the inserting section of an endoscope, as will be described with two embodiments later described.

### Variation Examples

The applicator and the closing member used in the above-described embodiment are not limited to those configured as described above. Various modifications can be made.

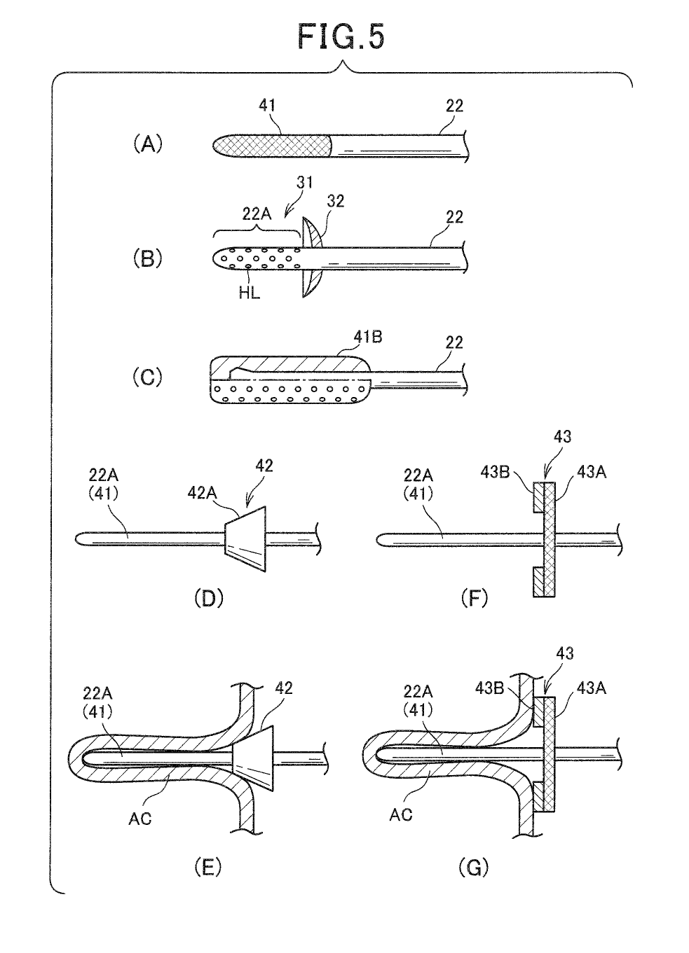

FIG. 5 shows a variation example of the applicator. An applicator 41 of the variation example shown in (A) of FIG. 5 is, for example, a mesh or a porous member composed of Teflon or nylon. The applicator 41 has a shape similar to that of the applicator 22A described above and is formed integrally with the tip end of the suction catheter 22.

An applicator 41A of the variation example shown in (B) of FIG. 5 has a shape similar to that of the applicator 22A described above and has numerous holes HL formed in the tip end section of the suction catheter 22. In other words, the applicator 41A is formed in the tip end of the suction catheter 22 as a portion of the suction catheter 22.

An applicator 41B of the variation example shown in (C) of FIG. 5 is a foam attached to the tip end section of the suction catheter 22.

(D) of FIG. 5 shows a variation example of the closing member. A closing member 42 can be used with the applicator 22A or the applicator 41 described above. The closing member 42 has a taper 42A that approximately matches the shape of the entrance of the opening section of the appendix AC. Therefore, the appendix AC can be closed such as to be plugged. The position of the closing member 42 can be prevented from shifting during a waiting period until negative pressure is applied. In this instance, as shown in (E) of FIG. 5, contact with the opening section of the appendix AC is further improved as a result of negative pressure being applied.

(F) of FIG. 5 shows another variation example of the closing member. A closing member 43 has a disk 43A composed of a resin, such as silicon, and an adhesive layer 43B. The adhesive layer 43B is applied in a ring shape along the circumferential section on the surface of the disk 43A on the appendix AC side. When the closing member 43 is used, as shown in (G) of FIG. 5, the adhesive layer 43B can be adhered to the edge of the opening section of the appendix AC. Therefore, in this instance as well, the position of the closing member 43 before suction can be prevented from shifting.

### Second Embodiment

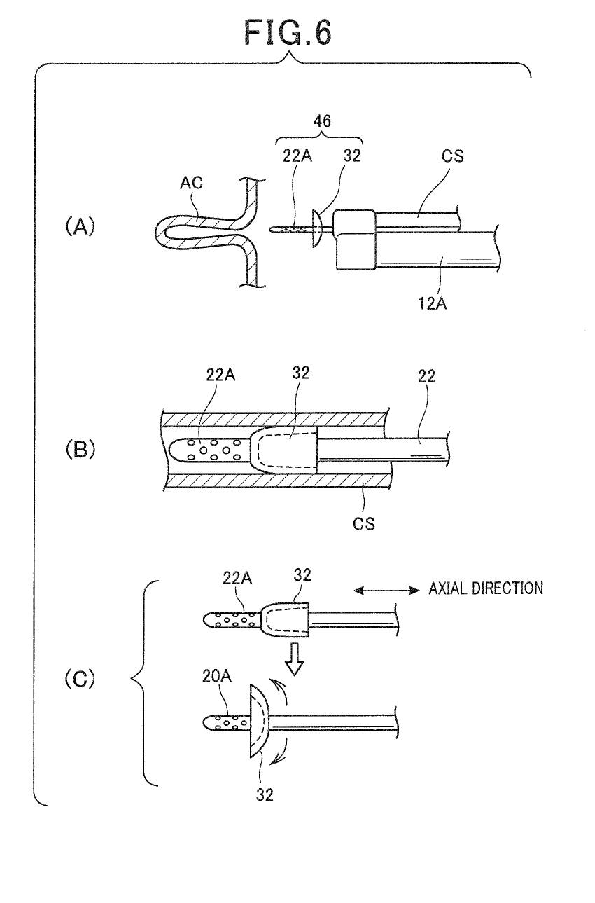

A second embodiment of the treatment system of the present invention will be described with reference to FIG. 6. In the second and subsequent embodiments, constituent components having the same or similar effects as those according to the first embodiment, described above, are given the same reference numbers. Descriptions thereof are omitted or simplified.

FIG. 6 shows, in its (A), a treatment device 46 used in the treatment system. The treatment device 46 has a structure in which the closing member 32 is integrally attached from the start to the applicator 22A positioned in the tip end section of the suction catheter 22. The structures of the suction catheter 22, the applicator 22A, and the closing member 32 are equivalent to those described above. As shown in (B) of FIG. 6, the integrated applicator 22A (a portion of the suction catheter 22) and the closing member 32 are placed within the channel of the endoscope 11 or an external guide tube CS of the endoscope 11. When the applicator 22A and the closing member 32 are housed, the closing member 32 is folded in a direction opposite of the direction in which the suction catheter 22 is pushed out. Therefore, when the suction catheter 22 is pushed out towards the appendix AC and emerges the tip end of the external guide tube CS (or the channel), as shown in (C) of FIG. 6, the closing member 32 is released from the folded state due to the elasticity thereof, and returns to the initial shape that is capable of closing the appendix AC.

Therefore, in a manner similar to that according to the first embodiment, when the applicator 22A is inserted into the appendix AC under the endoscope 11, the integrated closing member 32 comes into contact with the opening section of the appendix AC such as to close the opening section. As a result, in a manner similar to that according to the first embodiment, the negative pressure therapy can be performed.

Therefore, effects similar to those according to the first embodiment can also be achieved by the treatment device 46 according to the second embodiment. Furthermore, when the treatment device 46 is used, the position of the closing member 32 in the axial direction in relation to the applicator 22A is determined in advance. Therefore, compared to when the closing member 32 alone is subsequently sent as according to the first embodiment, the labor of sending the closing member 32 can be omitted.

The size of the appendix AC differs depending on the individual patient. Therefore, various types of treatment devices in which the sizes of the applicator 22A and the closing member 32, and the position of the closing member 32 in relation to the applicator 22A are changed are preferably prepared in advance. The treatment device can be selected to match the size of the appendix AC examined in advance through endoscopic observation.

### Third Embodiment

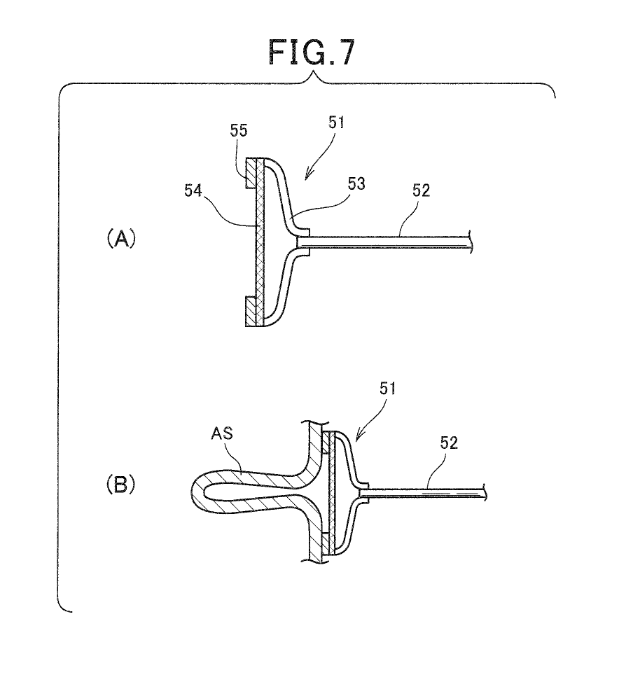

A third embodiment of the treatment system of the present invention will be described with reference to FIG. 7A and FIG. 7B.

FIG. 7A shows a treatment device 51 that is used in the treatment system. The treatment device 51 differs from that according to the first embodiment in that negative pressure is applied to the appendix AC without use of a suction catheter. The treatment device 51 includes a flexible, hollow silicon tube 52 and a silicon cup 53 attached to the tip end of the tube 52. The diameter of the cup 53 increases from the tip end of the tube 52, such that the cup 53 widens and is open towards the appendix AC side. The opening is covered by a meshed film 54. The film 54 may have air-permeability. Furthermore, an adhesive layer is applied in a ring shape in the outer peripheral section of the film 54. In a manner similar to that described above, the pressure tank 23 and the vacuum pump 26 are connected to the tube 52. The tube 52 is also introduced to the appendix AC through the channel of the endoscope 12 described above.

Therefore, as shown in FIG. 7B, although the treatment device 51 is not equipped with a catheter, the cup 53 can be set with certainty in the edge of the opening section of the appendix AC, and the negative pressure therapy can be performed.

In addition, the present invention is not limited to the configurations according to the above-described embodiments and variation examples thereof. Other suitable embodiments are possible through combination with conventionally known configurations, without departing from the scope of the invention recited in the scope of claims.

What is claimed is:

1. A method of treating a wound in a sac-like cavity inside of a subject using negative pressure therapy, the method comprising:
a first step of introducing, to the sac-like cavity, an applicator connected to a negative pressure source and a closing member that closes an opening of the cavity;
a second step of placing the applicator in the sac-like cavity and placing the closing member in contact with the edge of an opening section of the sac-like cavity;
a third step of driving the negative pressure source and applying negative pressure of a desired value to the sac-like cavity from the negative pressure source; and
a fourth step of performing the treatment by maintaining the negative pressure of the desired value in the sac-like cavity.

2. The method according to claim 1, wherein, in the second step, the applicator is inserted into the sac-like cavity, expanded, and placed in contact with the inner wall of the cavity.

3. The method according to claim 1, wherein, in the first step, a tip end section of a suction catheter connected to the negative pressure source is introduced, as the applicator, to the opening of the cavity, the tip end section in which a hole for air flow has been formed.

4. The method according to claim 3, wherein, in the first step, a member in the center of which the suction catheter penetrates in a slidable manner in an airtight state, having a size covering the edge of the opening, and capable of coming into close contact with the edge of the opening as a result of negative pressure is introduced, as the closing member, to the opening of the cavity.

5. The method according claim 3, wherein, in the second step, the applicator positioned in the tip end section of the suction catheter is inserted into the sac-like cavity and the closing member is then slid along the suction catheter, thereby placing the closing member in contact with the edge of the opening section of the sac-like cavity.

6. The method according to claim 5, wherein, in the first step, the suction catheter is introduced to the sac-like cavity under an endoscope, in a state in which the suction catheter is penetrating the closing member.

7. The method according to claim 1, wherein an adhesive for adhesion to a biological body is applied or a member increasing adhesion to a biological body is disposed in an area of the closing member that comes into contact with the edge of the opening of the cavity.

8. The method according to claim 2, wherein an adhesive for adhesion to a biological body is applied or a member increasing adhesion to a biological body is disposed in an area of the closing member that comes into contact with the edge of the opening of the cavity.

9. The method according to claim 3, wherein an adhesive for adhesion to a biological body is applied or a member increasing adhesion to a biological body is disposed in an area of the closing member that comes into contact with the edge of the opening of the cavity.

10. A method of treating a wound of a sac-like cavity inside of a subject using negative pressure therapy, the method comprising:
a first step of introducing, to the sac-like cavity, an applicator connected to a negative pressure source and a closing member that closes an opening of the cavity;
a second step of inserting the applicator into the sac-like cavity, expanding the applicator, and placing the applicator in contact with the inner wail of the cavity;
a third step of placing the closing member in contact with the edge of an opening section of the sac-like cavity;
a fourth step of driving the negative pressure source and applying negative pressure of a desired value to the sac-like cavity from the negative pressure source; and
a fifth step of performing the treatment by maintaining the negative pressure of the desired value in the sac-like cavity.

11. The method according to claim 10, wherein an adhesive for adhesion to a biological body is applied or a member increasing adhesion to a biological body is disposed in an area of the closing member that comes into contact with the edge of the opening of the cavity.

12. The method according to claim 11, wherein, in the first step, a member in the center of which a suction catheter penetrates in a slidable manner in an airtight state, having a size covering the edge of the opening, and capable of coming into close contact with the edge of the opening as a result of negative pressure is introduced, as the closing member, to the opening of the cavity.

13. The method according to claim 11, wherein:
in the second step, the applicator positioned in a tip end section of a suction catheter is inserted into the sac-like cavity; and
in the third step, the closing member is slid along the suction catheter, thereby coming into contact with the edge of the opening section of the sac-like cavity.

14. The method according to claim 11, wherein, in the first step, a suction catheter is introduced to the sac-like cavity under an endoscope, in a state in which the suction catheter is penetrating the closing member.
